(19) United States
(12) Patent Application Publication
(10) Pub. No.: US 2022/0141028 A1
(43) Pub. Date: May 5, 2022

(54) SECURE VAULT SYSTEM FOR PRIVATE KEY STORAGE

(71) Applicant: Xapo Holdings Limited, George Town (KY)

(72) Inventors: Carlos Maria Italo Rienzi Onnainty, Buenos Aires (AR); Alejandro Lopez, Buenos Aires (AR); Gabriel Becedillas, Buenos Aires (AR); Pablo Jorge, Buenos Aires (AR); Francisco Dibar, Buenos Aires (AR); Martin Apesteguía, Buenos Aires (AR)

(21) Appl. No.: 16/976,067

(22) PCT Filed: Jul. 23, 2019
(86) PCT No.: PCT/US2019/043105

§ 371 Date: Aug. 26, 2020

(51) Int. Cl. H04L 9/32; H04L 9/14; G06Q 20/38

(52) U.S. Cl. CPC H04L 9/3247; H04L 9/14; G06Q 2220/00; H04L 2209/56; G06Q 20/389

(57) ABSTRACT

A vault system provides a signing manager system and a signing system for transferring assets from a vault that are recorded in a distributed ledger. The signing manager system receives an order to transfer an asset from the vault, validates the order in various ways, and sends a signing request containing the order to the signing system. The signing system is implemented at a secure vault location and securely generates and stores vault private keys. Upon receiving the signing request, the signing system performs various validations, signs the transaction, and sends a signing response to the signing manager system. Upon receiving the signing response, the signing manager system validates the signing response and directs that the signed transaction be recorded in the distributed ledger.

### BACKGROUND

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key (or a hash of the public key, referred to as an “address”) of the new owner, is digitally signed by the owner with the owner's private key to transfer ownership to the new owner, as represented by the new owner public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

The bitcoin system is an example of a blockchain-based distributed ledger system. Other blockchain-based distributed ledger systems include Ethereum, Litecoin, Ripple, IOTA, and so on, which each support a type of cryptocurrency. To enable more complex transactions than the bitcoin system can support, some distributed ledger systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide on which transactions to keep and which transactions to discard.

“Wallet” software has been developed to help users of the bitcoin system to generate and store their public and private key pairs, submit transactions to be recorded in the blockchain, and track their account balances by their addresses, each address being, as described above, a hash of a public key of a public and private key pair of a user. For example, wallet software may list for each address the amount of unspent bitcoin associated with that address. Because a user's private key is needed when the user spends bitcoin that the user owns, users need to ensure that their private key is neither stolen nor lost. If their private key were stolen, then the thief could transfer the bitcoin assigned to the address of the corresponding public key to the thief's own address—meaning that the thief now owns the bitcoin. If a user's private key is lost, then the user could not spend the bitcoin assigned to the address of the corresponding public key—meaning that the user has effectively lost the bitcoin. Wallet software can provide mechanisms to help ensure that the private keys are neither stolen or lost.

Because most commerce is conducted using fiat currency rather than cryptocurrency, exchange organizations have been established to exchange cryptocurrency to fiat currency, and vice versa. For example, to exchange bitcoin for fiat currency, the owner of the bitcoin would transfer an amount of bitcoin to the exchange organization. The exchange organization would then determine the current exchange rate and credit a bank account (or other account) of the user with an amount of fiat currency corresponding to the amount of bitcoin, less a service fee. The user can then spend the fiat currency in their bank account.

At least one organization provides an additional service that helps ensure the security of the private keys and simplifies the process of exchanging cryptocurrency for fiat currency and conducting transactions with the fiat currency. Such an organization may, for example, purchase bitcoin that is assigned to a pool of its own addresses and allow its customers to purchase some of that bitcoin without actually transferring the bitcoin in the blockchain to the customers. The organization may maintain a database that, for each customer with an account, stores the amount of bitcoin of the pool that is owned by that customer in that account. The organization may provide its customers with debit cards that can be used to spend fiat currency. When a customer spends fiat currency using the debit card, the organization debits the customer's account an amount of bitcoin corresponding to the amount of fiat currency based on the current exchange rate. The organization may then exchange the amount of bitcoin of one of its addresses to fiat currency using an exchange organization. The organization may also delay the exchange when the organization believes that the exchange rate between bitcoin and the fiat currency will improve, meaning that the organization can exchange the amount of bitcoin for an amount of fiat currency that is greater than the amount credited to the customer.

Such an organization may organize its addresses into a hot pool and a cold pool. The private keys corresponding to the addresses of the hot pool and the cold pool are stored in what is referred to as “hot storage” and “cold storage,” respectively. The hot storage is available in real time so that the private keys can be used to exchange cryptocurrency to fiat currency as needed to meet the anticipated demands of its customers. The cold storage is offline and is thus not available in real time. Although the hot storage and the cold storage are both very secure, the cold storage is even more secure because it is always offline, reducing the possibility of being hacked.

### BRIEF DESCRIPTION OF THE DRAWINGS

FIG. 1 is a block diagram that illustrates components of, and that interact with, the SVS in some embodiments.

FIG. 2 provides flow diagrams illustrating processing of the SMS at a high level in some embodiments.

FIG. 3 provides flow diagrams illustrating processing of the SS at a high level in some embodiments.

FIG. 4 is a block diagram that illustrates components of the SMS in some embodiments.

FIG. 5 is a block diagram that illustrates components of the SS in some embodiments.

FIG. 6 is a flow diagram that illustrates the processing of a receive order component of the PPSS in some embodiments.

FIG. 7 is a flow diagram that illustrates processing of a receive signing request from PPSS component of the SMSS in some embodiments.

FIG. 8 is a flow diagram of a receive signing request from SPSS component of the SMSS in some embodiments.

FIG. 9 is a flow diagram that illustrates the processing of a send signing request to OnSSS component of the SMSS in some embodiments.

FIG. 10 is a flow diagram that illustrates the processing of a receive signing response from OnSSS component of the SMSS in some embodiments.

FIG. 11 is a flow diagram that illustrates the processing of a receive signing request from SMSS component of the SPSS in some embodiments.

FIG. 12 is a flow diagram illustrating the processing of a receive signing response from SMSS component of the SPSS in some embodiments.

FIG. 13 is a flow diagram that illustrates the processing of a receive signing request from SMSS component of the OnSSS in some embodiments.

FIG. 14 is a flow diagram that illustrates the processing of a send signing response to SMSS component of the OnSSS in some embodiments.

FIG. 15 is a flow diagram that illustrates the processing of a receive signing request component of the OffSSS in some embodiments.

FIG. 16 is a flow diagram that illustrates the processing of a receive signing response component of the OffSSS in some embodiments.

FIG. 17 is a flow diagram that illustrates the processing of a sign transaction component of the SSS in some embodiments.

FIG. 18 is a flow diagram that illustrates the processing of a verify signatures component of the SSS in some embodiments.

### DETAILED DESCRIPTION

A method and system for securely storing private keys in a vault and transferring assets that are assigned to addresses associated with the private keys is provided. In some embodiments, a secure vault system (“SVS”) generates a vault private key and stores the vault private key in a vault storage of the vault. The vault private key has an associated vault public key that is used to create a vault address. To store an asset securely in the vault, the asset may be transferred to the vault by recording a transaction in a distributed ledger to transfer the asset to the vault address. Once the transaction is recorded, the asset cannot be transferred out of the vault without the SVS signing with the vault private key a subsequent transaction to transfer the asset from the vault address to a destination address that is a non-vault address (e.g., an address of a hot pool). The SVS employs rigorous security measures to minimize the chances of a vault private key being compromised. The assets may include any type of tangible or intangible asset. For example, an asset may be an amount of cryptocurrency, an amount of fiat currency, a bullion or coin of a precious metal, a vehicle, fine art, real property, and so on.

To help provide rigorous security measures, the SVS includes a signing manager system and multiple signing systems. The signing systems are implemented in the vault, which is a distributed vault system with different vault locations, typically on different continents. Each vault location provides a secure facility that may be hardened to minimize the effects of natural and manmade disasters such as floods, earthquakes, and explosions. Each vault location includes the signing system and employs security measures to restrict access to the signing system. Moreover, a transaction to transfer assets from the vault may require the signature of the signing system of multiple vault locations, for example, a multi-sig transaction of the bitcoin system. The signing manager system coordinates the validating of a transaction to transfer an asset from the vault, the collecting of signatures of the signing systems on the transaction, and the recording of the signed transaction in the distributed ledger.

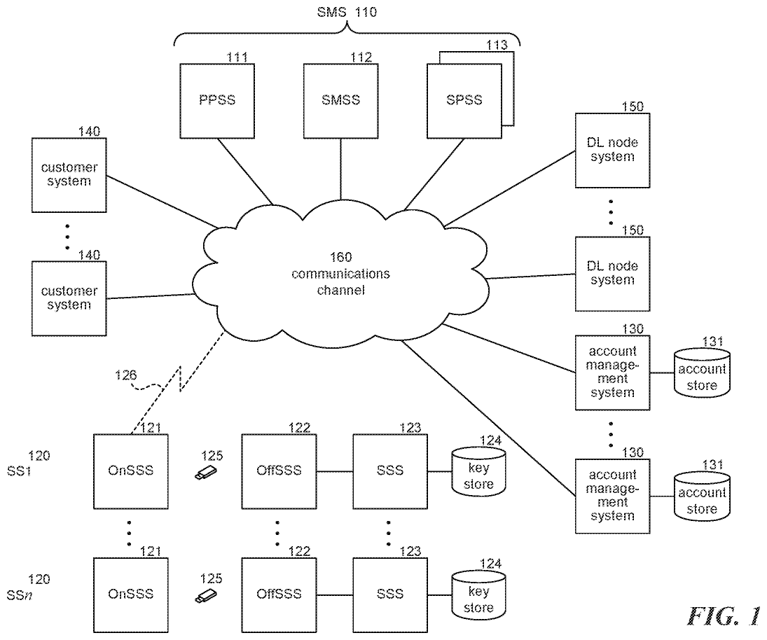

FIG. 1 is a block diagram that illustrates components of, and that interact with, the SVS in some embodiments. The SVS includes a signing manager system (“SMS”) 110 and signing systems (“SSs”) 120. The SVS also includes components of account management systems 130. The SVS interacts with customer systems 140 and node systems of the distributed ledger 150. The systems communicate via communications channel 160. The SMS includes a primary policy subsystem (“PPSS”) 111, a signing manager subsystem (“SMSS”) 112, and one or more secondary policy subsystems (“SPSS”) 113. Each SS includes an online signing subsystem (“OnSSS”) 121, an offline signing subsystem (“OffSSS”) 122, and a signing subsystem (“SSS”) 123. Each SSS includes a key store 124 for securely storing private keys. Each SSS also includes a device 125, such as a USB thumb drive, for transferring data between the OnSSS and the OffSSS. Each OnSSS is connected to the communications channel only when transferring data between the SMS and OnSSS as indicated by the dashed connection line 126. The account management systems manage customer accounts, including tracking balances of each account and customer vault addresses and generating orders to transfer assets from the vault. The account management systems also track a cold pool and a hot pool. The account management systems may implement a distributed database with data stored redundantly in account stores 131. The account management systems may communicate using various security techniques such as public key certificates, encryption, and so on to ensure that the account stores are synchronized. If an account management system were to be compromised, the account stores of the other account management systems can be checked to prevent transferring assets as a result of the compromise. The customer systems provide a user interface for interacting with the account management system and include a user interface for wallet management to transfer assets to and from the vault. The distributed ledger node systems may implement a distributed ledger system such as a blockchain. The communications channel may be the Internet.

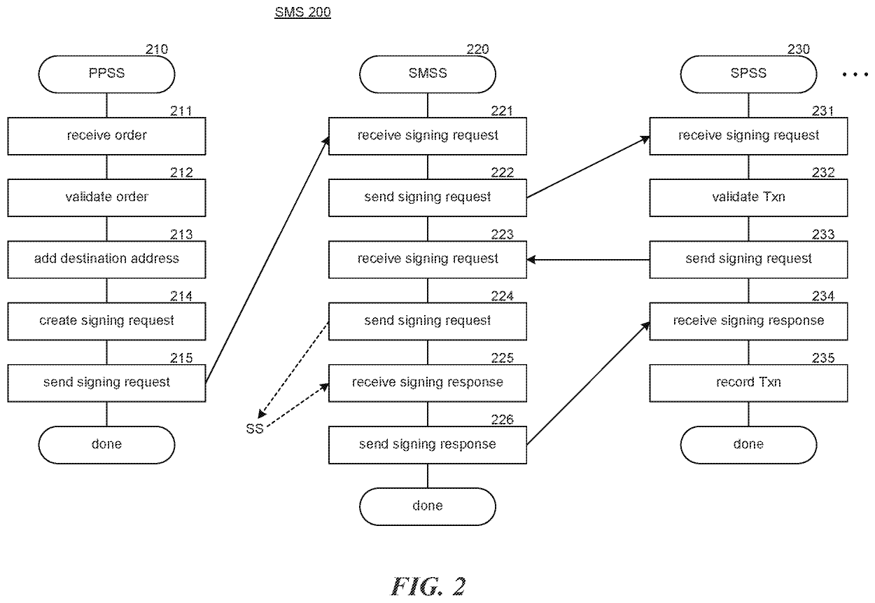

FIG. 2 provides flow diagrams illustrating processing of the SMS at a high level in some embodiments. The SMS 200 includes the PPSS, the SMSS, and the SPSS as represented by flow diagrams 210, 220, and 230, respectively.

In block 211, the PPSS receives an order to transfer an asset from a customer vault address to a destination address that is outside the vault, such as an address of the hot pool. The order may be received from an account management system and may identify the customer and include a transaction that identifies the asset, the input transaction that includes the customer vault address as an output (i.e., the source address), and other data of the transaction to transfer the asset out of the vault, The PPSS may also verify that the order was signed by the account management system. In block 212, the PPSS validates the order by, for example, ensuring that output of the input transaction has not been spent, checking an account management system to determine whether the customer vault address is associated with the identified customer, and so on. In block 213, the PPSS adds a destination address to the transaction. The PPSS may select (e.g., randomly) a hot address from the hot pool as the destination address. In block 214, the PPSS creates a signing request that includes the transaction. In block 215, the PPSS sends the signing request to the SMSS and then completes.

In block 221, the SMSS receives the signing request from the PPSS. In block 222, the SMSS sends the signing request to the SPSS. In block 223, the SMSS receives the signing request from the SPSS. In block 224, the SMSS sends the signing request to the SS. The dashed lines indicate that the SMSS is connected to the SS only when a signing request is being sent or a signing response is being received. In block 225, the SMSS receives a signing response from the SS. The signing response includes the signed transaction. In block 226, the SMSS sends the signing response to the SPSS and then completes,

In block 231, the SPSS receives the signing request from the SMSS. In block 232, the SPSS validates the transaction, for example, by ensuring that the output of the input transaction has not been spent, checking a different account management system than that checked by the PPSS to determine whether the customer vault address is associated with the identified customer, and so on. The checking of a different account management system helps ensure that if one account management system is compromised, the transaction will not be validated. In block 233, the SPSS sends the signing request to the SMSS. In block 234, the SPSS receives the signing response from the SMSS, In block 235, the SPSS directs recording of the signed transaction in a distributed ledger and then completes.

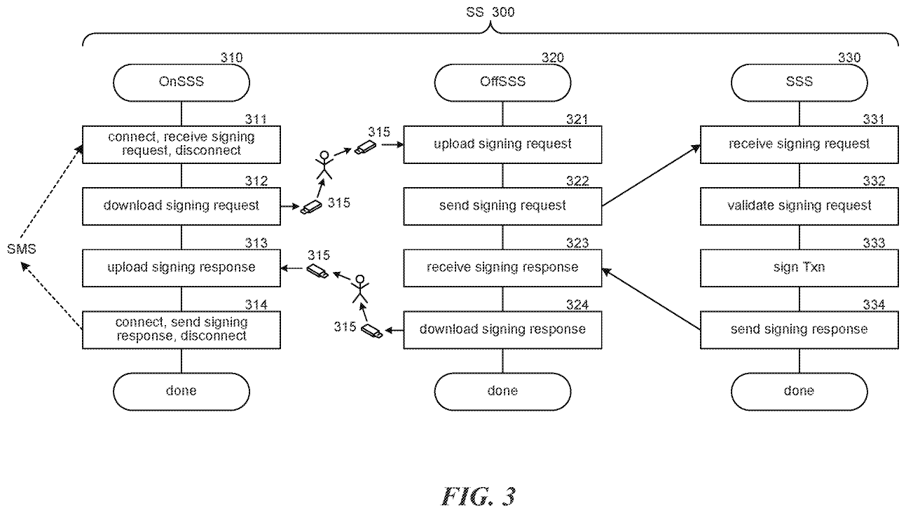

FIG. 3 provides flow diagrams illustrating processing of the SS at a high level in some embodiments. The SS 300 includes the OnSSS, the OffSSS, and the SSS as represented by flow diagrams 310, 320, and 330, respectively. The OnSSS, the OffSSS, and the SSS may be located in separate rooms of the vault for security reasons, with the SSS being located in the most secure room.

In block 311, the OnSSS connects to the SMS, receives a signing request from the SMS, and disconnects from the SMS. The dashed lines indicate that the OnSSS is connected to the SMS only when receiving a signing request and sending a signing response, In block 312, a device 315 is connected to the OnSSS, the OnSSS downloads the signing request to the device, and the device containing the signing request is disconnected from the OnSSS. The device containing the signing request is then transported to the OffSSS (e.g., by a person). In block 313, the device containing a signing response is connected to the OnSSS, the OnSSS uploads the signing response from the device, and the device is disconnected from the OnSSS. In block 314, the OnSSS connects to the SMS, sends the signing response to the SMS, disconnects from the SMS, and then completes.

In block 321, the device containing the signing request is connected to the OffSSS, the OffSSS uploads the signing request, and the device is disconnected from the OffSSS. In block 322, the OffSSS sends the signing request to the SSS. In block 323, the OffSSS receives the signing response from the SSS. In block 324, the device is connected to the OffSSS, the OffSSS downloads the signing response to the device and completes, and the device is disconnected from the OffSSS. The device containing the signing response is then transported to the OnSSS.

In block 331, the SSS receives the signing request from the OffSSS. In block 332 the SSS validates the signing request. In block 333, the SSS signs the transaction with a customer private key associated with the customer vault address that is the source address. In block 334, the SSS sends the signing response to the OffSSS and completes,

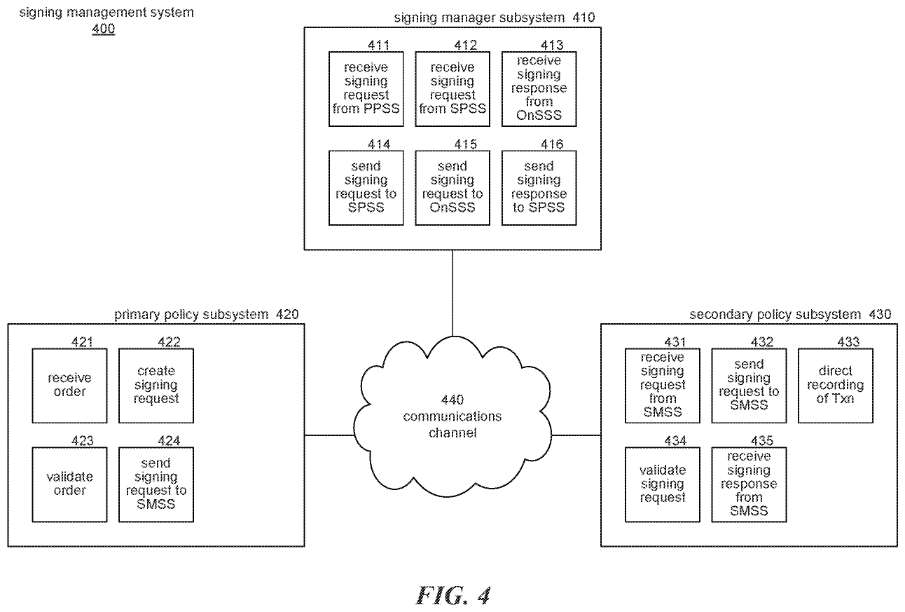

FIG. 4 is a block diagram that illustrates components of the SMS in some embodiments. The SMS 400 includes an SMSS 410, a PPSS 420, and one or more SPSSs 430, which are connected via communications channel 440.

The SMSS includes a receive signing request from PPSS component 411, a receive signing request from SPSS component 412, a receive signing response from OnSSS component 413, a send signing request to SPSS component 414, a send signing request to OnSSS component 415, and a send signing response to SPSS component 416. The receive signing request from PPSS component verifies the signature of the PPSS and invokes the send signing request to SPSS component. The send signing request to SPSS component may sign the signing request and sends the signing request to the SPSS. The receive signing request from SPSS component verifies the signature of the SPSS and the SMSS, if included. The receive signing request from SPSS component may also send the signing request to other SPSSs until a pre-specified number of the SPSSs have signed the signing request. The signatures from multiple SPSSs help prevent the validation of fraudulent transactions as a result of a single SPSS being compromised. The receive signing request from SPSS component receives the signing request and stores the signing request in a queue for sending to the OnSSS. The send signing request to OnSSS component, upon having a connection established with the OnSSS that is initiated by the OnSSS, sends one or more signing requests that are in the queue to the OnSSS. The receive signing response from OnSSS component, upon having a connection established with the OnSSS that is initiated by the OnSSS, receives a signing response from the OnSSS. If the required number of SSs have not signed the transaction of the signing response, the receive signing response from OnSSS component stores a signing request containing the signed transaction in a queue for sending to another SS. If the required number of SSs have signed the transaction of the signing response, the receive signing response from ONSSS component invokes the send signing response to SPSS component for recording the signed transaction in the distributed ledger.

The PPSS includes a receive order component 421, a create signing request component 422, a validate order 423, and a send signing request to SMSS component 424. The receive order component receives an order to transfer an asset from the vault and invokes the validate order component. The validate order component validates the order, for example, by verifying that the order was sent from an account management system, validating that the inputs to the transaction are not spent, and so on. After the order has been validated, that create signing request component creates a signing request that includes a destination address from a hot store address pool. The send signing request to SMSS component signs the signing request and sends the signed signing request to the SMSS.

The SPSS includes a receive signing request from SMSS component 431, a send signing request to SMSS component 432, a direct recording of the transaction component 433, a validate signing request component 434, and a receive signing response from SMSS component 435. The receive signing request from SMSS component receives a signing request and invokes the validate signing request component and the send signing request to SMSS component. The validate signing request component validates the signing request, for example, by verifying that it was sent from the SMSS, validating that the inputs to the transaction are not spent, and so on. The send signing request to SMSS component sends the validated signing request to the SMSS. The receive signing response from SMSS component receives from the SMSS a signing response that has been signed by the required number of SSs and invokes the direct recording of the transaction component to direct the recording of the signed transaction in the distributed ledger.

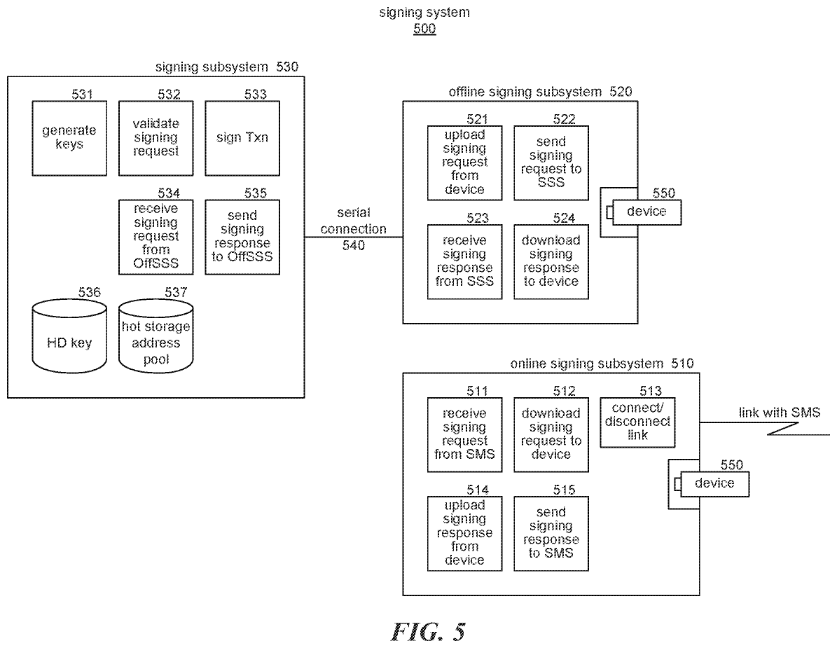

FIG. 5 is a block diagram that illustrates components of the SS in some embodiments. The SS 500 includes an OnSSS 510, and OffSSS 520, and an SSS 530.

The OnSSS includes a receive signing request from SMS component 511, a download signing request to device component 512, a connect/disconnect link component 513, an upload signing response from device component 514, and a send signing response to SMS component 515. The receive signing request from SMS component invokes the connect/disconnect link component to connect to the SMS, receives the signing request from the SMS, and invokes the connect/disconnect link component to disconnect from the SMS. The connect/disconnect link component authenticates that the OnSSS is connected to the SMS. The receive signing request from SMS component may also verify the signatures of the SMS. The download signing request to device component encrypts the signing request and downloads the encrypted signing request to device 550. The device is then disconnected from the OnSSS and transported to and connected to the OffSSS. The device with the signing response is disconnected from the OffSSS and transported to the OnSSS. When the device is connected to the OnSSS, the upload signing response from device component uploads the signing response from the device and decrypts the signing response. The upload signing response from device component then invokes the send signing response to SMS component. The send signing response to SMS component invokes the connect/disconnect link to connect to the SMS, sends the signing response to the SMS, and invokes the connect/disconnect link to disconnect from the SMS.

The OffSSS includes an upload signing request from device component 521, a send signing request to SSS component 522, a receive signing response from SSS component 523, and a download signing response to device component 524. When a device containing a signing request is connected to the OffSSS, the upload signing request from device component uploads the signing request from the device and decrypts the signing request. The upload signing request from device component invokes the send signing request to SSS component to send the signing request to the SSS via a serial connection 540. The receive signing response from SSS component receives a signing response from the SSS via the serial connection and invokes the download signing response to device component. The download signing response to device component encrypts the signing response and downloads the signing response to the device. The device is then disconnected from the OffSSS and transported to the OnSSS.

The SSS includes a generate keys component 531, a validate signing request component 532, a sign transaction component 533, a receive signing request from OffSSS component 534, a send signing response to OffSSS component 535, a hierarchal deterministic key store 536, and a hot storage address pool store 537. The generate keys component generates customer private keys from a master private key that is stored in the hierarchical deterministic key store 536. The receive signing request from OffSSS component receives a signing request from the OffSSS via the serial connection. The receive signing request from OffSSS component invokes the validate signing request component to validate the signing request. The signing request may be validated, for example, to verify that the destination address is an address in the hot pool, verify that the source address is associated with a customer vault address whose private key is in the hierarchal deterministic key store, check signatures of the PPSS and the SPSSs, and so on. The receive signing request from OffSSS component then invokes the sign transaction component to sign the transaction of the signing request and creates a signing response that contains the signed transaction. The send signing response to OffSSS component then sends the signing request via the serial connection to the OffSSS.

The computing systems (e.g., nodes) on which the SVS may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the SVS. The data transmission media are used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The SVS may be described in the general context of computer-executable instructions, such as program modules and components, executed by one or more computers, processors, or other devices. Generally, program modules or components include routines, programs, objects, data structures, and so on that perform tasks or implement data types of SVS. Typically, the functionality of the program modules may be combined or distributed as desired in various examples. Aspects of the SVS may be implemented in hardware using, for example, an application-specific integrated circuit (“ASIC”) or field programmable gate array (“FPGA”).

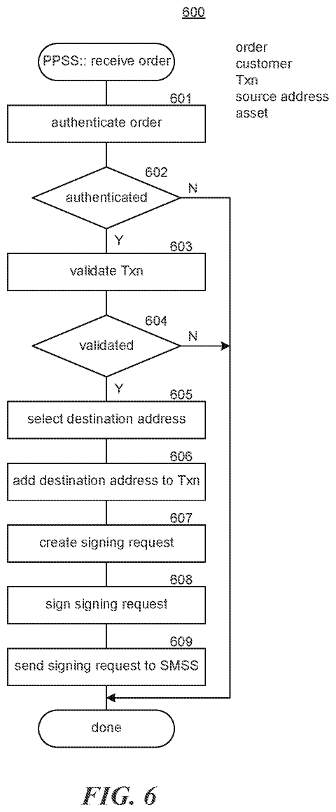

FIG. 6 is a flow diagram that illustrates the processing of a receive order component of the PPSS in some embodiments. The receive order component 600 is invoked, passing an indication of an order that includes a customer identifier and a transaction that includes an indication of the asset to transfer, an input transaction whose output is to a customer vault address for the customer, that is, the source address, and so on. In block 601, the component authenticates the order, for example, to verify that it is signed by the account management system. In decision block 602, if the order has been authenticated, then the component continues at block 603, else the component completes. In block 603, the component validates the transaction, for example, by checking that the customer vault address is associated with the customer, checking that the output of the input transaction has not been spent, checking multiple databases of the account management system to confirm the order, and so on. In decision block 604, if the transaction is validated, the component continues at block 605, else the component completes. In block 605, the component selects a destination address from the hot pool. The component may select the destination address randomly from the hot pool (or from a subset of the hot pool designated for transfers from customer vault addresses), based on the amount of assets assigned to an address in the hot pool, and so on. In block 606, the component adds the destination address to the transaction. In block 607, the component creates a signing request that contains the transaction. In block 608, the component signs the signing request. In block 609, the component sends the signing request to the SMSS and completes.

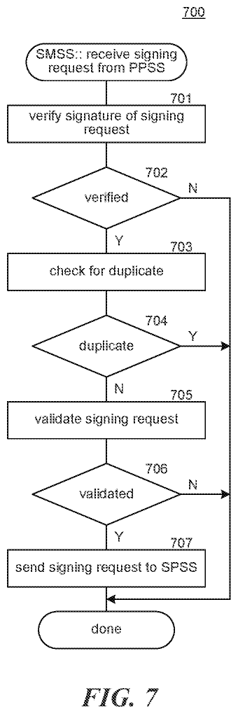

FIG. 7 is a flow diagram that illustrates processing of a receive signing request from PPSS component of the SMSS in some embodiments. The receive signing request from PPSS component 700 receives a signing request from the PPSS, validates the request, and sends the signing request to one or more SPSSs. In block 701, the component verifies the signature of the PPSS on the signing request. In decision block 702, if the signature is verified, then the component continues at block 703, else the component completes. In block 703, the component checks to determine whether this is a duplicate signing request. In decision block 704, if the signing request is a duplicate, then the component completes. else the component continues at block 705. In block 705, the component validates the signing request to ensure the validity of the information in the signing request. In decision block 706, if the signing request has been validated, then the component continues at block 707, else the component completes. In block 707, the component sends the signing request to an SPSS and completes.

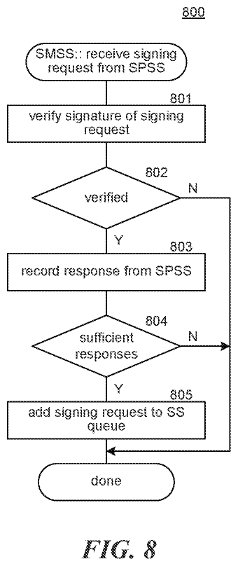

FIG. 8 is a flow diagram of a receive signing request from SPSS component of the SMSS in some embodiments. The receive signing request from SPSS component 800 is invoked when a signing request is received from an SPSS and queues the request for sending to one or more SSs. In block 801, the component verifies the signature of the SPSS and PPSS on the signing request. In decision block 802, if the signatures are verified, then the component continues at block 803, else the component completes. In block 803, the component records that a response has been received from that SPSS. In decision block 804, if sufficient responses have been received from SPSSs, then the component continues at block 805, else the component completes. In block 805, the component adds the signing request to an SS queue for sending to the SS and completes.

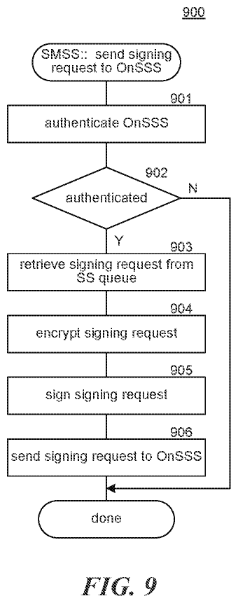

FIG. 9 is a flow diagram that illustrates the processing of a send signing request to OnSSS component of the SMSS in some embodiments. The send signing request to OnSSS component 900 is invoked when an OnSSS establishes a connection with the SMSS and sends one or more signing requests from the SS queue to the OnSSS. In block 901, the component authenticates the OnSSS, for example, based on a public key certificate. In decision block 902, if the OnSSS has been authenticated, then the component continues at block 903, else the component completes. In block 903, the component retrieves a signing request from the SS queue. If the SS queue is empty, then the component may simply send a response to indicate that there is no signing request to send. In block 904, the component encrypts the signing request. In block 905, the component may sign the signing request. In block 906, the component sends the signing request to the OnSSS and completes.

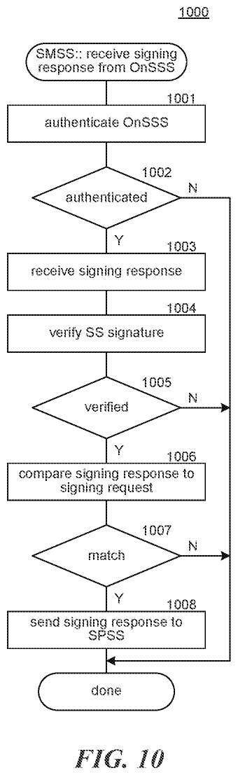

FIG. 10 is a flow diagram that illustrates the processing of a receive signing response from OnSSS component of the SMSS in some embodiments. The receive signing response from OnSSS component 1000 is invoked when an OnSSS establishes a connection with the SMSS indicating that a signing response is to be sent, In block 1001, the component authenticates the OnSSS, for example, based on a public key certificate. In decision block 1002, if the OnSSS is authenticated, then the component continues at block 1003, else the component completes. In block 1003, the component receives the signing response from the OnSSS. In block 1004, the component verifies the signature of the SS. In decision block 1005, if the signature is verified, then the component continues at block 1006, else the component completes. In block 1006, the component compares the signing response to signing requests that have been sent to the OnSSS. In decision block 1007, if there is a match, then the component continues at block 1008, else the component completes. In block 1008, the component sends the signing response to an SPSS if the required number of SSs have signed the transaction and then completes. Otherwise, the component may add a signing request to the SS queue that includes a partially signed transaction. Alternatively, the component may send each signing response to an SPSS and let the SPSS decide when to record the transaction.

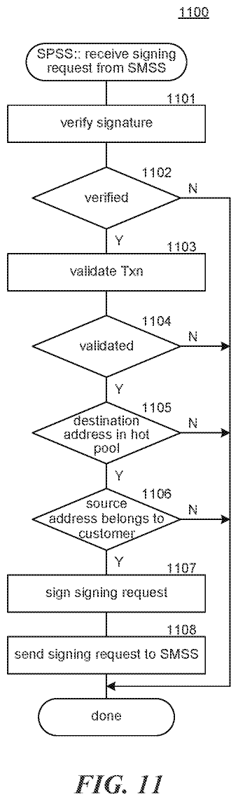

FIG. 11 is a flow diagram that illustrates the processing of a receive signing request from SMSS component of the SPSS in some embodiments. The receive signing request from SMSS component 1100 receives the signing request from the SMSS, validates the signing request, and returns the signing request to the SMSS. In block 1101, the component verifies the signature of the PPSS (and the SMSS if included) on the signing request. In decision block 1102, if the signatures are verified, then the component continues at block 1103, else the component completes. In block 1103, the component validates the transaction. The component validates the transaction, for example, by checking a database of the account management system that is separate from the databases used by the PPSS, ensuring that the transaction matches the corresponding order of the customer, ensuring that any change (i.e., leftover asset) will go back to the customer vault address, any transaction fees are appropriate, and so on. In decision block 1104, if the transaction is validated, then the component continues at block 1105, else the component completes. In decision block 1105, if the destination address is in the hot pool, then the component continues at block 1106, else the component completes. In decision block 1106, if the source address is a customer vault address that belongs to the customer, then the component continues at block 1107, else the component completes. In block 1107, the component signs the signing request. In block 1108, the component sends the signing request to the SMSS and completes.

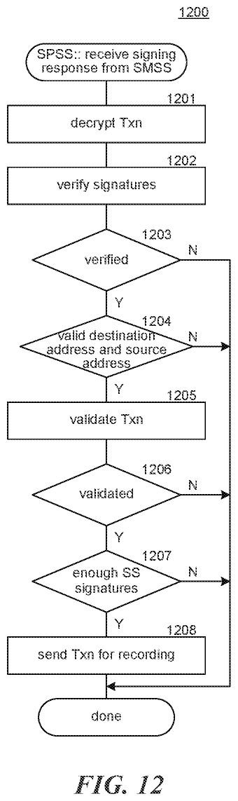

FIG. 12 is a flow diagram illustrating the processing of a receive signing response from SMSS component of the SPSS in some embodiments. The receive signing response from SMSS component 1200 is invoked when a signing response is received from the SMSS. In block 1201, the component decrypts the transaction in the signing response, which may be encrypted by the SS. In block 1202, the component verifies the signatures of the SPSS and the PPSS on the transaction. In decision block 1203, if the signatures are verified, then the component continues at block 1204, else the component completes. In decision block 1204, the component ensures that the destination address is in the hot pool and that the source address is a customer vault address of the customer. If so, the component continues at block 1205, else the component completes. In block 1205, the component validates the transaction in a manner similar to the validation performed when the corresponding signing request was received by the SPSS. In decision block 1206, if the transaction is validated, then the component continues at block 1207, else the component completes. In decision block 1207, if the transaction includes enough signatures of SSs, then the component continues at block 1208, else the component completes. In block 1208, the component sends the transaction to the distributed ledger for recording and completes.

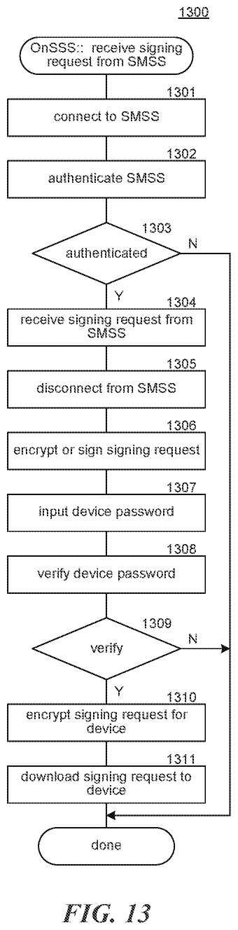

FIG. 13 is a flow diagram that illustrates the processing of a receive signing request from SMSS component of the OnSSS in some embodiments. The receive signing request from SMSS component 1300 is invoked to retrieve a signing request from the SMSS. In block 1301, the component establishes the connection to the SMSS, for example, at the request of a user located in the vault. In block 1302, the component authenticates the SMSS, for example, based on a public key certificate. In decision block 1303, if the SMSS is authenticated, then the component continues at block 1304, else the component completes. In block 1304, the component receives a signing request from the SMSS. In block 1305, the component disconnects from the SMSS. In block 1306, the component encrypts the signing request using a key of the OnSSS. In block 1307, the component inputs a device password from a user of the OnSSS. In block 1308, the component verifies the device password. In decision block 1309, if the device password is verified, then the component continues at block 1310, else the component completes. In block 1310, the component encrypts the signing request using a key of the device. In block 1311, the component downloads the signing request to the device and completes.

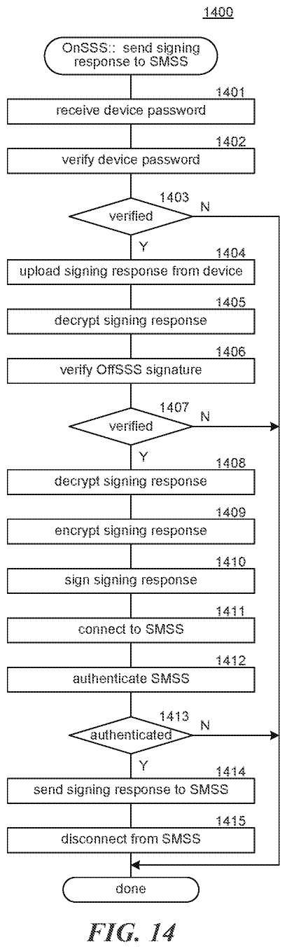

FIG. 14 is a flow diagram that illustrates the processing of a send signing response to SMSS component of the OnSSS in some embodiments. The send signing response to SMSS component 1400 is invoked when a device containing a signing response is connected to the OnSSS. In block 1401, the component receives a device password from the user. In block 1402, the component verifies the device password. In decision block 1403, if the device password is verified, then the component continues at block 1404, else the component completes. In block 1404, the component uploads the signing response from the device. In block 1405, the component decrypts the signing response using a key of the device. In block 1406, the component verifies the signature of the OffSSS. In decision block 1407, if the signature is verified, then the component continues at block 1408, else the component completes. In block 1408, the component decrypts the signing response using a public key of the OffSSS. In block 1409, the component encrypts the signing response. In block 1410, the component signs the signing response. In block 1411, the component connects to the SMSS. In block 1412, the component authenticates the SMSS, for example, based on a public key certificate. In decision block 1413, if the SMSS has been authenticated, then the component continues at block 1414, else the component completes. In block 1414, the component sends the signing response to the SMSS, In block 1415, the component disconnects from the SMSS and completes.

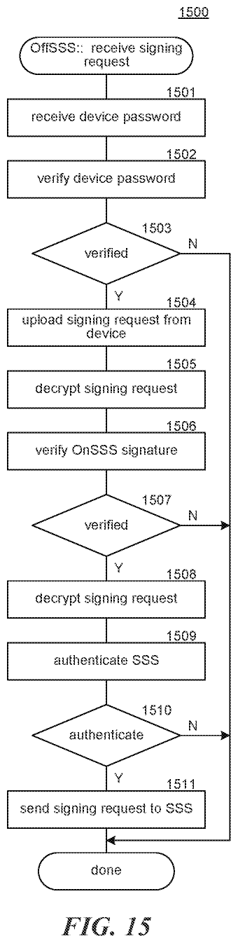

FIG. 15 is a flow diagram that illustrates the processing of a receive signing request component of the OffSSS in some embodiments. The receive signing request component 1500 is invoked when a device is connected to the OffSSS. In block 1501, the component receives the device password from a user. In block 1502, the component verifies the device password. In decision block 1503, if the device password is verified, then the component continues at block 1504, else the component completes. In block 1504, the component uploads the signing request from the device. The component may also disconnect the device from the OffSSS. In block 1505; the component decrypts the signing request using a key of the device. In block 1506, the component verifies the OnSSS signature on the signing request. In decision block 1507, if the request is verified, then the component continues at block 1508, else the component completes. In block 1508, the component decrypts the signing request using a public key of the OnSSS. In block 1509, the component authenticates the SSS. In decision block 1510, if the SSS is authenticated, then the component continues at block 1511, else the component completes. In block 1511, the component sends the signing request to the SSS and completes.

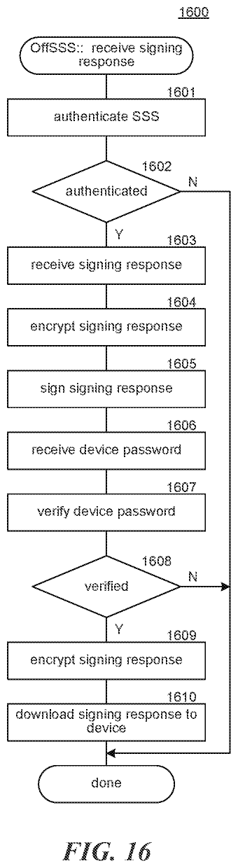

FIG. 16 is a flow diagram that illustrates the processing of a receive signing response component of the OffSSS in some embodiments. The receive signing response component 1600 is invoked when a signing response is to be received from the SSS. In block 1601 the component authenticates the SSS. In decision block 1602, if the SSS is authenticated, then the component continues at block 1603, else the component completes. In block 1603, the component receives the signing response from the SSS. In block 1604, the component encrypts the signing response. In block 1605, the component signs the signing response. In block 1606, the component receives the device password from a user. In block 1607, the component verifies the device password. In block 1608, if the device password is verified, then the component continues at block 1609, else the component completes. In block 1609, the component encrypts the signing response using a device key. In block 1610, the component downloads the signing response to the device and completes.

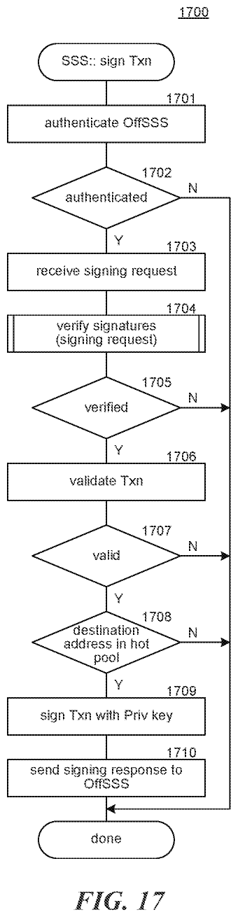

FIG. 17 is a flow diagram that illustrates the processing of a sign transaction component of the SSS in some embodiments. The sign transaction component 1700 is invoked when the OffSSS indicates to send a signing request. In block 1701, the component authenticates the OffSSS, In decision block 702, if the OffSSS has been authenticated, then the component continues at block 1703, else the component completes. In block 1703, the component receives the signing request from the OffSSS via the serial connection. In block 1704, the component invokes a verify signatures component, passing an indication of the signing request. In decision block 1705, if the signatures have been verified, then the component continues at block 1706, else the component completes. In block 1706, the component validates the transaction by, for example, ensuring that the source address is a customer vault address. In decision block 1707, if the transaction is valid, then the component continues at block 1708, else the component completes. In decision block 1708, if the destination address is in the hot pool (or in a designated subset of the hot pool), then the component continues at block 1709, else the component completes. In block 1709, the component signs the transaction with the private key associated with the customer vault address. In block 1710, the component sends a signing response that includes the signed transaction to the OffSSS and completes.

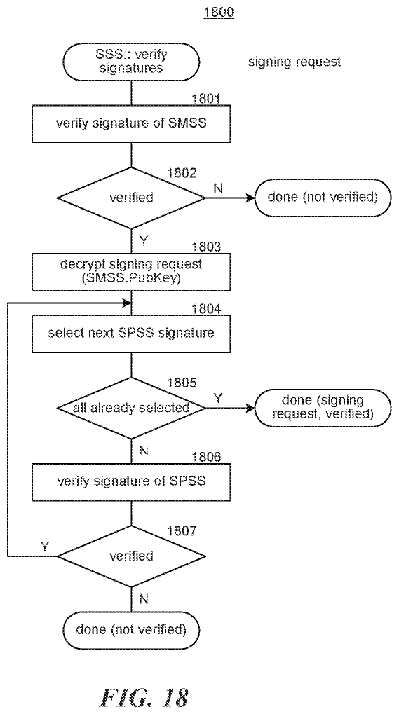

FIG. 18 is a flow diagram that illustrates the processing of a verify signatures component of the SSS in some embodiments. The verify signatures component 1800 is passed an indication of a signing request and returns an indication of whether the signatures of the signing request have been verified. In block 1801, the component verifies the signature of the SMSS. In decision block 1802, if the signature of the SMSS has been verified, then the component continues at block 1803, else the component completes, indicating that the signatures have not been verified. In block 1803, the component decrypts the signing request with the public key of the SMSS. In blocks 1804-1807, the component verifies the SPSS signatures of the signing request. In block 1804, the component selects the next SPSS signature of the signing request. In decision block 1805, if all the signatures have already been selected, then the component returns the decrypted signing request and an indication that the signatures have been verified, else the component continues at block 1806. In block 1806, the component verifies the selected signature. In decision block 1807, if the selected signature is verified, then the component loops to block 1804 to select the next signature, else the component completes, indicating that the signatures have not been verified.

The following paragraphs describe various embodiments of aspects of the SVS. An implementation of the SVS may employ any combination of the embodiments. The processing described below may be performed by a computing device with a processor that executes computer-executable instructions stored on a computer-readable storage medium that implements the SVS.

In some embodiments, a method performed by a signing subsystem of a signing system of a vault is provided for securely storing private key information associated with addresses of a distributed ledger. The signing subsystem is offline. The method accesses the private key information stored on a storage medium of the signing subsystem. The method generates and stores vault private keys from a master private key of the private key information. The vault private keys are associated with vault addresses based on vault public keys corresponding to the vault private keys. The method receives, via a connection to an offline subsystem of the signing system, a signing request containing a transaction for transferring an asset from a source vault address to a destination non-vault address that is a non-vault private key that is not stored in the vault. The method validates the transaction. The method signs the transaction with the vault private key associated with the source vault address. The method sends via the connection to the offline subsystem a signing response containing the signed transaction. The offline subsystem downloads the signing response to a removable device for transport to an online subsystem of the signing system that sends the signing response for recording the signed transaction in the distributed ledger. In some embodiments, the signing system is located in the vault and the signing subsystem is located in a first secure room of the vault, the offline subsystem is located in a second secure room of the vault, and the signing subsystem is connected to the offline subsystem via a wired connection. In some embodiments, the wired connection is a serial connection. In some embodiments, the method further generates a vault private key for each of a plurality of wallets of customers. In some embodiments, the generating of the vault private keys employs hierarchical deterministic key technology. In some embodiments, the method validates by validating that the signing request was received from the offline subsystem, validating that the signing request was signed by a signing manager system, and validating that a destination address of the transaction is a non-vault address. In some embodiments, the method further signs the signing request with a private key of the signing subsystem. In some embodiments, the asset is an amount of a cryptocurrency. In some embodiments, the distributed ledger is a blockchain. In some embodiments, the source vault address is associated with an entity that has rights to transfer the asset to a non-vault address. In some embodiments, the entity owns the asset.

In some embodiments, a vault system is provided for ensuring security of private keys. The vault system includes a signing manager system and a signing system. The signing manager system receives an order to transfer an asset from a vault address to a non-vault address, generates a signing request containing a transaction to transfer the asset from the vault address to the non-vault address, sends the signing request to the signing system for signing the transaction, receives a signing response containing the signed transaction from the signing system, and directs recording of the signed transaction in a distributed ledger. The signing system includes an online subsystem, an offline subsystem, and a signing subsystem. The online subsystem receives the signing request from the signing manager system, downloads the signing request to a removable device, uploads the signing response from the removable device, and sends the signing response to the signing manager system. The offline subsystem is offline but connected to the signing subsystem and uploads the signing request from the removable device, sends the signing request to the signing subsystem, receives the signing response from the signing subsystem, and downloads the signing response to the removable device. The signing subsystem is offline and stores vault private keys for vault addresses, receives the signing request from the offline subsystem, signs the transaction with a vault private key to generate the signed transaction, and sends the signing response to the offline subsystem. In some embodiments, the signing system is located in a vault facility, the signing subsystem is located in a first secure room of the vault facility, the offline subsystem is located in a second secure room of the vault facility, and the online subsystem is located in a third secure room of the vault facility. In some embodiments, the removable device is removed from the online subsystem, transported from the third secure room to the second secure room, and connected to the offline subsystem. In some embodiments, the signing subsystem and the offline subsystem are connected to each other, but not connected to any other system that is online. In some embodiments, the signing manager system includes a signing manager subsystem, a primary policy subsystem, and one or more secondary policy subsystems, the primary policy subsystem and the one or more secondary policy subsystems being connected to the signing manager subsystem. The primary policy subsystem receives the order, validates the order, generates the signing request, and sends the signing request to the signing manager subsystem. The signing manager subsystem receives from the primary policy subsystem the signing request, ensures that the signing request was sent from the primary policy subsystem, sends the signing request to a secondary policy subsystem, receives the signing request from the secondary policy subsystem, ensures that the signing request was sent from the secondary policy subsystem, sends the signing request received from the secondary policy subsystem to the online subsystem for signing by the signing subsystem, receives the signing response from the online subsystem, and sends the signed transaction to the secondary policy subsystem. The secondary policy subsystem receives the signing request from the signing manager subsystem, validates the signing request, sends the signing request to the signing manager subsystem, receives the signing response, and directs recording of the signed transaction in the distributed ledger. In some embodiments, the signing manager subsystem sends the signing request to multiple secondary policy subsystems and receives the signing request from multiple secondary policy subsystems and wherein the signing manager subsystem sends the signing request to the online subsystem only when sufficient multiple secondary policy subsystems have validated the signing request. In some embodiments, the primary policy subsystem and the secondary policy subsystem each sign the signing request so that the signing subsystem can verify the origin of the signing request. In some embodiments, the signing manager system signs the signing request prior to sending the signing request to the online subsystem and the signing subsystem checks the signature. In some embodiments, the vault system further comprises a plurality of signing systems and the signing manager system directs recording of the transaction only after multiple signing systems have signed the transaction. In some embodiments, the signing manager subsystem sends the signing request to the multiple signing systems with a delay between sending the transaction to successive signing systems as a precaution against a possible unauthorized order to transfer the asset. In some embodiments, the transaction includes a source address and a destination address and the signing subsystem validates the transaction to ensure that the destination address is a non-vault address of a hot pool. In some embodiments, the signing subsystem employs a hierarchical deterministic key technology to generate, from a vault master private key, customer vault private keys. In some embodiments, the source address is derived from a vault public key corresponding to a vault private key.

In some embodiments, a method performed by a signing system for signing a transaction is provided. The signing system includes an online subsystem, an offline subsystem, and a signing subsystem. The method establishes a connection between the online subsystem and a signing manager system. The method receives by the online subsystem a signing request containing the transaction from the signing manager system. The method disconnects the connection with the signing manager system. The method connects to a removable device to the online subsystem. The method downloads the signing request from the online subsystem to the removable device. The method disconnects from the removable device from the online subsystem. The method connects to the removable device to the offline subsystem. The method sends the signing request via a connection from the offline subsystem to the signing subsystem. The method signs the transaction by the signing subsystem. In some embodiments, the method further ensures by the online subsystem that the signing request is signed by the signing manager system and ensures by the offline subsystem that the signing request is signed by the online system. In some embodiments, the method further ensures by the signing subsystem that the signing request is signed by a primary policy subsystem and a secondary policy subsystem of the signing manager system. In some embodiments, the transaction includes a source address and a destination address and further comprising ensuring by the signing subsystem that the destination address is in a non-vault address of a hot pool. In some embodiments, the method further sends a signing response containing the signed transaction via the connection to the offline subsystem from the signing subsystem. The method downloads the signing response to a removable device. The method disconnects the removable device from the offline subsystem. The method connects the removable device to the online subsystem. The method uploads the signing response from the removable device to the online subsystem. The method establishes a connection between the online subsystem and the signing manager system. The method sends from the online subsystem to the signing manager system the signing response. The method disconnects the connection with the signing manager system. In some embodiments, the signing request is encrypted by the online subsystem prior to downloading to the removable device and decrypted by the offline subsystem after uploading from the removable device.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

We claim:

1. A method performed by a signing subsystem of a signing system of a vault for securely storing private key information associated with addresses of a distributed ledger, the signing subsystem being offline, the method comprising:
accessing the private key information stored on a storage medium of the signing subsystem;
generating and storing vault private keys from a master private key of the private key information, the vault private keys being associated with vault addresses based on vault public keys corresponding to the vault private keys;
receiving via a connection to an offline subsystem of the signing system a signing request containing a transaction for transferring an asset from a source vault address to a destination non-vault address that is a non-vault private key that is not stored in the vault;
validating the transaction;
signing the transaction with the vault private key associated with the source vault address; and
sending via the connection to the offline subsystem a signing response containing the signed transaction,
wherein the offline subsystem downloads the signing response to a removable device for transport to an online subsystem of the signing system that sends the signing response for recording the signed transaction in the distributed ledger.

2. The method of claim 1 wherein the signing system is located in the vault and the signing subsystem is located in a first secure room of the vault, the offline subsystem is located in a second secure room of the vault, and the signing subsystem is connected to the offline subsystem via a wired connection.

3. The method of claim 2 wherein the wired connection is a serial connection.

4. The method of claim 1 further comprising generating a vault private key for each of a plurality of wallets of customers.

5. The method of claim 4 wherein the generating of the vault private keys employs hierarchical deterministic key technology.

6. The method of claim 1 wherein the validating comprises:
validating that the signing request was received from the offline subsystem;
validating that the signing request was signed by a signing manager system; and
validating that a destination address of the transaction is a non-vault address.

7. The method of claim 1 further comprising signing the signing request with a private key of the signing subsystem.

8. The method of claim 1 wherein the asset is an amount of a cryptocurrency.

9. The method of claim 1 wherein the distributed ledger is a blockchain.

10. The method of claim 1 wherein the source vault address is associated with an entity that has rights to transfer the asset to a non-vault address.

11. The method of claim 10 wherein the entity owns the asset.

12. A vault system for ensuring security of private keys, the vault system comprising a signing manager system and a signing system, wherein
the signing manager system receives an order to transfer an asset from a vault address to a non-vault address, generates a signing request containing a transaction to transfer the asset from the vault address to the non-vault address, sends the signing request to the signing system for signing the transaction, receives a signing response containing the signed transaction from the signing system, and directs recording of the signed transaction in a distributed ledger; and
the signing system includes an online subsystem, an offline subsystem, and a signing subsystem, wherein
the online subsystem receives the signing request from the signing manager system, downloads the signing request to a removable device, uploads the signing response from the removable device, and sends the signing response to the signing manager system;
the offline subsystem is offline but connected to the signing subsystem and uploads the signing request from the removable device, sends the signing request to the signing subsystem, receives the signing response from the signing subsystem, and downloads the signing response to the removable device; and
the signing subsystem is offline and stores vault private keys for vault addresses, receives the signing request from the offline subsystem, signs the transaction with a vault private key to generate the signed transaction, and sends the signing response to the offline subsystem.

13. The vault system of claim 12 wherein the signing system is located in a vault facility, the signing subsystem is located in a first secure room of the vault facility, the offline subsystem is located in a second secure room of the vault facility, and the online subsystem is located in a third secure room of the vault facility.

14. The vault system of claim 13 wherein the removable device is removed from the online subsystem, transported from the third secure room to the second secure room, and connected to the offline subsystem.

15. The vault system of claim 12 wherein the signing subsystem and the offline subsystem are connected to each other, but not connected to any other system that is online.

16. The vault system of claim 12 wherein the signing manager system includes a signing manager subsystem, a primary policy subsystem, and one or more secondary policy subsystems, the primary policy subsystem and the one or more secondary policy subsystems being connected to the signing manager subsystem, wherein
the primary policy subsystem receives the order, validates the order, generates the signing request, and sends the signing request to the signing manager subsystem;
the signing manager subsystem receives from the primary policy subsystem the signing request, ensures that the signing request was sent from the primary policy subsystem, sends the signing request to a secondary policy subsystem, receives the signing request from the secondary policy subsystem, ensures that the signing request was sent from the secondary policy subsystem, sends the signing request received from the secondary policy subsystem to the online subsystem for signing by the signing subsystem, receives the signing response from the online subsystem, and sends the signed transaction to the secondary policy subsystem; and
the secondary policy subsystem receives the signing request from the signing manager subsystem, validates the signing request, sends the signing request to the signing manager subsystem, receives the signing response, and directs recording of the signed transaction in the distributed ledger.

17. The vault system of claim 16 wherein the signing manager subsystem sends the signing request to multiple secondary policy subsystems and receives the signing request from multiple secondary policy subsystems and wherein the signing manager subsystem sends the signing request to the online subsystem only when sufficient multiple secondary policy subsystems have validated the signing request.

18. The vault system of claim 16 wherein the primary policy subsystem and the secondary policy subsystem each sign the signing request so that the signing subsystem can verify the origin of the signing request.

19. The vault system of claim 12 wherein the signing manager system signs the signing request prior to sending the signing request to the online subsystem and the signing subsystem checks the signature.

20. The vault system of claim 12 further comprising a plurality of signing systems and wherein the signing manager system directs recording of the transaction only after multiple signing systems have signed the transaction.

21. The vault system of claim 20 wherein the signing manager subsystem sends the signing request to the multiple signing systems with a delay between sending the transaction to successive signing systems as a precaution against a possible unauthorized order to transfer the asset.

22. The vault system of claim 12 wherein the transaction includes a source address and a destination address and the signing subsystem validates the transaction to ensure that the destination address is a non-vault address of a hot pool.

23. The vault system of claim 22 wherein the signing subsystem employs a hierarchical deterministic key technology to generate, from a vault master private key, customer vault private keys.

24. The vault system of claim 23 wherein the source address is derived from a vault public key corresponding to a vault private key.

25. A method performed by a signing system for signing a transaction, the signing system including an online subsystem, an offline subsystem, and a signing subsystem, the method comprising:
establishing a connection between the online subsystem and a signing manager system;
receiving by the online subsystem a signing request containing the transaction from the signing manager system;
disconnecting the connection with the signing manager system;
connecting to a removable device to the online subsystem;
downloading the signing request from the online subsystem to the removable device;
disconnecting from the removable device from the online subsystem;
connecting to the removable device to the offline subsystem;
sending the signing request via a connection from the offline subsystem to the signing subsystem; and
signing the transaction by the signing subsystem.

26. The method of claim 25 further comprising ensuring by the online subsystem that the signing request is signed by the signing manager system and ensuring by the offline subsystem that the signing request is signed by the online system.

27. The method of claim 25 further comprising ensuring by the signing subsystem that the signing request is signed by a primary policy subsystem and a secondary policy subsystem of the signing manager system.

28. The method of claim 25 wherein the transaction includes a source address and a destination address and further comprising ensuring by the signing subsystem that the destination address is in a non-vault address of a hot pool.

29. The method of claim 25 further comprising:
sending a signing response containing the signed transaction via the connection to the offline subsystem from the signing subsystem;
downloading the signing response to a removable device;
disconnecting the removable device from the offline subsystem;
connecting the removable device to the online subsystem;
uploading the signing response from the removable device to the online subsystem;
establishing a connection between the online subsystem and the signing manager system;
sending from the online subsystem to the signing manager system the signing response; and
disconnecting the connection with the signing manager system.

30. The method of claim 25 wherein the signing request is encrypted by the online subsystem prior to downloading to the removable device and decrypted by the offline subsystem after uploading from the removable device,
